(19) United States
(12) Patent Application Publication
(10) Pub. No.: US 2009/0131254 A1
(43) Pub. Date: May 21, 2009

(54) Desiccant

(76) Inventor: Yih-Ming Wu, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,541

(22) Filed: May 21, 2008

(30) Foreign Application Priority Data
Nov. 20, 2007 (TW) 96219620

(51) Int. Cl. B01J 20/00

(52) U.S. Cl. 502/400

(57) ABSTRACT

An improved desiccant is made from moisture-proof material and is capable of being received in a container. The desiccant has at least an inner wall and an outer wall. The inner wall encircles a cavity for accommodating goods. The cavity can be kept dry, preventing the goods received therein from moisture. The desiccant enlarges moisture-proof area.

### BACKGROUND OF THE INVENTION

1. Field of the Invention

The present invention relates to a desiccant, and particularly to a desiccant which can accommodate goods and which enlarges moisture-proof area.

2. Related Art

Dryness is commonly required in a container for preventing goods therein from deteriorating or rotten. Typically, a package desiccant (also called damp-proof bag) 100 is received in a container 200 for purpose of maintaining desiccation, as shown in FIG. 6. In most cases, the desiccant 100 is placed on a bottom of the container 200. In restraint of positions, damp-proof area is limited in the container, and even, the optimal damp-proof area is limited to the vicinity of the bottom of the container. This cannot take effect adequately in practical application cases.

A moisture-proof can is proposed to avoid absorption of moisture. This moisture-proof can comprises a hermetically sealed container. Once the sealed container is opened, moisture enters the sealed container, markedly decreasing its impermeable effect. In some cases, desiccant material is provided on a bottom or a cover of a moisture-proof can. In another cases, a package desiccant is directly disposed in the moisture-proof can. Regardless of the above, limitation of damp-proof area has not been overcome.

### SUMMARY OF THE INVENTION

To overcome the shortcomings, an object of the present invention is to provide an improved desiccant for enlarging moisture-proof area and enhancing moisture-proof effect.

The desiccant is made from moisture-proof material for preventing from moisture, and comprises at least an inner wall and an outer wall, the inner wall encircling a cavity for accommodating goods. The cavity can be kept dry, whereby goods received in the cavity are completely prevented from moisture for maintaining contemplated freshness.

### BRIEF DESCRIPTION OF THE DRAWINGS

FIG. 1 is a perspective view of an improved desiccant of the present invention.

FIG. 2 is a top view of FIG. 1.

FIG. 3 shows the desiccant of FIG. 1 placed in a container.

FIG. 4 is a schematic view of the desiccant according to a second embodiment of the present invention, wherein the desiccant further comprises a lid and a bottom wall.

FIG. 5 is a schematic view of the desiccant according to a third embodiment of the present invention, wherein the desiccant is rectangular.

FIG. 6 exemplarily shows a conventional desiccant placed in a container.

### DESCRIPTION OF THE PREFERRED EMBODIMENTS

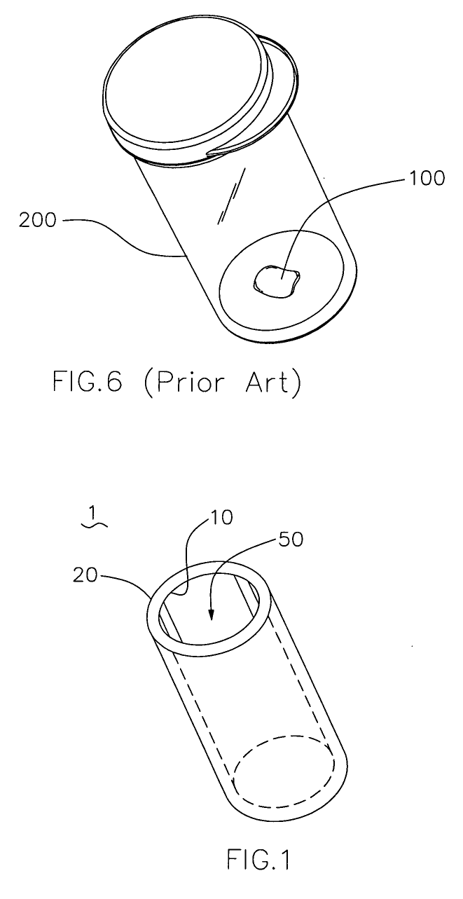

With reference to FIGS. 1 and 2, an improved desiccant is made from damp-proof material, which comprise one or more ingredients which can absorb moisture, for example, calcium chloride, calcium oxide, anhydride phosphate, silica gel or the like. The desiccant comprises an inner wall 10 and an outer wall 20. In one embodiment, the inner wall 10 and the outer wall 20 are formed unitarily and telescopically. The inner wall 10 encircles a cavity 50 which is maintained to be damp-proof.

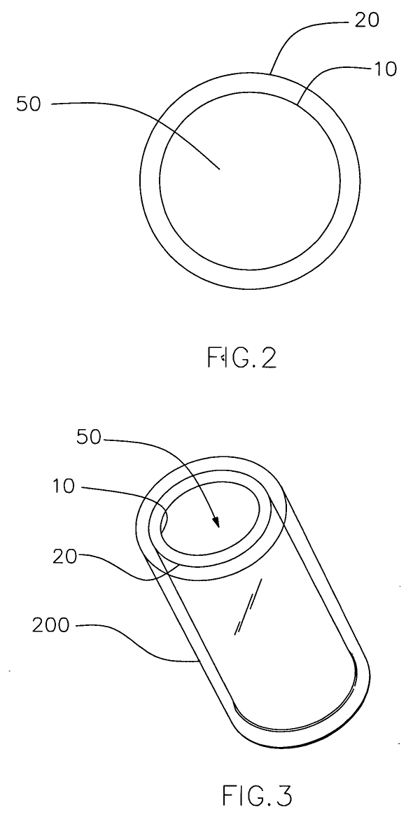

The desiccant 1 is able to vary in volume according to volumes of containers for suiting for different containers. Further referring to FIG. 3, the desiccant 1 is put into a container 200 with appropriate volume for preventing absorption of moisture. The cavity 50 may accommodate all kinds of goods, such as tea leaves, drugs, precise electronic components and so on, whereby these goods may be prevented against humidity and keep contemplated freshness. Correspondingly, the moisture-proof area is enlarged.

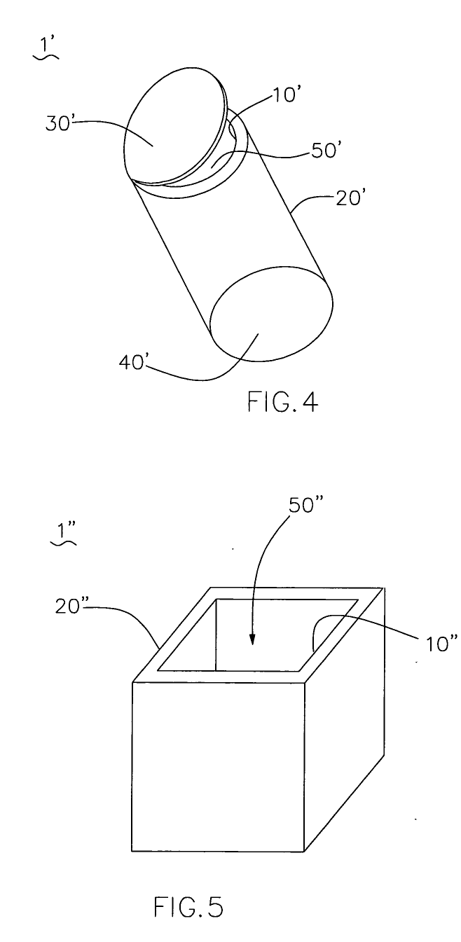

FIG. 4 shows a second embodiment of the present invention. A desiccant 1′ of the second embodiment comprises an inner wall 10′, an outer wall 20′ and a cavity 50′ as the same as the inner wall 10, the outer wall 20 and the cavity 50 of the first embodiment. The desiccant 1′ further comprises a lid 30′ integrally formed with the inner wall 10′ and the outer wall 20′ for enclosing a top of the cavity 50′, thereby further preventing against moisture at the top of the cavity 50′. The lid 30′ can be opened and closed. The desiccant 1′ further comprises a bottom wall 40′ integrally formed with the inner wall 10′ and the outer wall 20′ for enclosing a bottom of the cavity 50′, thereby further preventing against moisture at the bottom of the cavity 50′. The desiccant 1′ is a complete container with a sealable lid, and thereby can be solely provided for accommodating goods. The desiccant 1′ can also be received in a particular container (not shown) for containing goods and preventing from moisture.

FIG. 5 shows a third embodiment of the present invention. A desiccant 1″ of the third embodiment comprises an inner wall 10″, an outer wall 20″ and a cavity 50″ similar to the inner wall 10, the outer wall 20 and the cavity 50 of the first embodiment except that the inner wall 10″ and the outer wall 20″ are rectangular for suiting for containers with other shapes, for example rectangular containers. Similarly, all kinds of goods may be received in the cavity 50″ and be prevented against damp for maintaining fresh.

It is understood that the invention may be embodied in other forms without departing from the spirit thereof. Thus, the present examples and embodiments are to be considered in all respects as illustrative and not restrictive, and the invention is not to be limited to the details given herein.

1. A desiccant being made from moisture-proof material for preventing from moisture, and comprising:
at least an inner wall and an outer wall, the inner wall encircling a cavity for accommodating goods.

2. The desiccant as claimed in claim 1, wherein the inner wall and the outer wall are formed integrally and telescopically.

3. The desiccant as claimed in claim 2, wherein the inner wall and the outer wall is changeable in volume according to volumes of containers for suiting for different containers.

4. The desiccant as claimed in claim 3, further comprising a bottom wall integrally formed with the inner wall and the outer wall for enclosing a bottom of the cavity, thereby further preventing against moisture at the bottom of the cavity.

5. The desiccant as claimed in claim 4, further comprising a lid integrally formed with the inner wall and the outer wall for enclosing a top of the cavity, thereby further preventing against moisture at the top of the cavity.

6. The desiccant as claimed in claim 5, wherein the lid is sealable, whereby in use, the desiccant can be solely provided for accommodating goods, and can be received in a particular container.
